(19) United States
(12) Patent Application Publication
(10) Pub. No.: US 2002/0132871 A1
(43) Pub. Date: Sep. 19, 2002

(54) Transparent UV curable coating system

(76) Inventors: Martin Colton, Longmeadow, MA (US); Robert Batson, Newington, CT (US)

Correspondence Address: Howard N. Flaxman, WELSH & FLAXMAN LLC, Suite 112, 2341 Jefferson Davis Hwy., Arlington, VA, 22202, US

(21) Appl. No.: 10/095,041

(22) Filed: Mar. 12, 2002

Related U.S. Application Data
(63) Continuation-in-part of application No. 09/709,535, filed on Nov. 13, 2000.
(63) Continuation-in-part of application No. 09/709,537, filed on Nov. 13, 2000.
(63) Continuation-in-part of application No. 09/874,305, filed on Jun. 6, 2001.

(51) Int. Cl. C08F 2/48; C08F 2/46; C08J 3/28; C08G 2/00

(52) U.S. Cl. 522/7; 427/508

(57) ABSTRACT

A UV/visible light reactive coating material to provide a permanent, hard, durable protective coating to stone, ceramic, glass, metal and hard plastics. The coating material comprises a novel blend of photoinitiators, UV curable resin blends, blends of specific acrylate and methacrylated monomers, a wetting agent, UV absorbers and stabilizers, a rheology modifier, adhesive agents, air-release agents and self leveling agents plus miscellaneous additives to impart specific properties required.

### CROSS-REFERENCE TO RELATED APPLICATIONS

This U.S. Patent Application is a continuation-in-part of U.S. patent application Ser. Nos. 09/709,535, filed Nov. 13,2000, entitled “FRICTIONAL UV CURABLE COATING SYSTEM”, 09/709,537, filed Nov. 13, 2000, entitled “A GLASS REPAIR SYSTEM UTILIZING A TRANSPARENT UV CURABLE COATING” and 09/874,305, filed Jun. 6, 2001, entitled “A GLASS REPAIR SYSTEM UTILIZING A TRANSPARENT UV CURABLE COATING”, all of which relate to U.S. patent application Ser. No. 09/709,583, filed Nov. 13, 2000, entitled “TRANSPARENT UV CURABLE SYSTEM, which is abandoned and all of which are based upon U.S. Provisional Patent Application Serial No. 60/164,818, filed Nov. 12, 1999, and entitled “TRANSPARENT UV CURABLE SYSTEM”.

### BACKGROUND OF THE INVENTION

1. Field of the Invention The invention relates to clear, durable, permanent, protective coating systems. More particularly, the invention relates to a rapid curing, single component, permanent coating system which is highly solvent resistant to resist staining, and may be readily repaired for the removal of a variety of undesirable markings including paints, scratching and gouging. The invention further relates to a novel UV photoinitiator combination in conjunction with a novel combination of monomers and resins to give unique properties to a permanent coating system which is readily photopolymerized into a hard, durable, thermoset plastic coating. The coating is noted for its clarity, non-yellowing, surface curing, solvent, abrasion and temperature resistance with exceptionally good adhesive properties to stone, ceramics, metals, glass and hard plastics.

2. Description of the Prior Art

Various coating techniques have been developed in the prior art for protecting and enhancing easily and regularly damaged surfaces. Unfortunately, prior art coating techniques have not fully addressed the commercial needs associated with protecting and enhancing valuable surfaces in an efficient and economical manner. In addition, many prior art coating products allow for the generation of toxic fumes and smoke when exposed to flame or severe heat, and may provide a safety hazard in public buildings and conveyances.

For example, many prior art coating systems employ solvent-based, high VOC content coating compositions such as toluene based acrylic lacquers. These coating compositions offer micro-thin, brittle coatings which do not resist scratching, are not easily repaired and must be totally removed before reapplication.

Other current coatings are two-part meter-mix coatings. The coatings require extensive surface preparation and curing time, have the presence of odors, and yellow or otherwise discolor with time and exposure to light.

Protective film coatings, which are placed on the surface to be protected as a thin plastic film, are also known in the prior art for protecting an underlying surface. However, these film coatings can be easily removed from the surface by simply lifting an edge and peeling the film from the underlying surface. Once removed from the underlying surface, the surface may be readily marred and otherwise defaced. In addition, these films may be readily burned and shredded.

As such, a need exists for a coating system offering an economical, efficient, and reliable alternative to prior art coating techniques. The present invention provides such a coating system

### SUMMARY OF THE INVENTION

It is, therefore, an object of the present invention to provide a light reactive coating material. The coating material comprises a UV or visible light or combination of both photoinitiator(s), a combination of UV curable resins, a combination of acrylate and methacrylate monomers, a wetting agent, a combination of UV absorbers and stabilizers, a rheology modifier, a bulk stabilizing system to prevent prepolymerizaton, a combination of adhesive agents, as well as self leveling and air release agents. Adhesion promotion primers are used with the coating material in order to promote long term durability by prevent delamination on difficult-to-bond surfaces such as marble, glass, stone, hard plastics and metals when exposed to moisture over long periods of time.

Other object, and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a cross section view of the present coating system applied as an anti-slip surface.

FIG. 2 is a cross section view of the present coating system applied as a glass coating system

FIG. 3 is a cross section view of the present coating system applied as a protective coating.

FIG. 4 is a cross section view of the present coating system applied as an anti-graffiti coating.

### DESCRIPTION OF THE PREFERRED EMBODIMENTS

The detailed embodiments of the present invention are disclosed herein. It should be understood, however, that the disclosed embodiments are merely exemplary of the invention, which maybe embodied in various forms. Therefore, the details disclosed herein are not to be interpreted as limited, but merely as the basis for the claims and as a basis for teaching one skilled in the art how to make and/or use the invention.

The coating system in accordance with the present invention provides a permanent, clear, hard, dry to the touch coating which maybe applied in thick or thin coatings to durable surfaces. The coating system provides a permanent protective coating from many solvent-based products, such as, inks, stains, wines, food substances, drinks and paints where alcohol, acetone or other solvents are used as the main ingredient. Solvent and temperature resistance are two important properties of the coating. The coating system also protects underlying surfaces from scratching, abrading and/or discoloration. The coating has long-term color stability by being non-yellowing when exposed to sunlight or other wave energy over long periods of time.

The features of the present coating system are achieved by providing a coating material preferably composed of a unique combination of UV curable resins blended together in various combinations to provide a very tough, hard and durable surface. The formulation of the present coating material permits its effective use at a multitude of viscosities. The versatility in potential viscosities which may be used in accordance with the present invention permits the present coating system to be used for coating vertical and/or horizontal surfaces in a wide range of coating thicknesses to give a natural look to the substrate being coated.

Photopolymerization of the chemically reactive coating formulation is ensured by the addition of a variety of photoinitiators to the coating material in a manner which is discussed below in greater detail. Rapid curing is achieved through the application of wave energy curing. In accordance with a preferred embodiment, ultraviolet (“UV”) and/or visible light photopolymerization is the preferred mode, although it is contemplated that infrared wave energy may also be utilized in conjunction with the photoinitiation for a variety of surface curing properties or as the total source of wave energy.

The curing technique used in accordance with a preferred embodiment of the present invention relies upon a combination of UV and visible light (as defined by wavelengths from 220 nanometers to 380 nanometers for UV and 380 nanometers to 480 nanometers for visible light). The combination of UV and visible light curing permits the use of cationic or free radical curing systems as known to those skilled in the art and described in current commercial chemical literature. This allows for extremely rapid curing, normally in seconds, of broad area coatings with minimal odor, heat, time and energy requirements. The present coating system's ability to produce a desirable coating with minimal odor, heat, time and energy requirements makes it highly suitable for commercial, as well as residential, areas.

In accordance with preferred embodiments of the present coating system, the coating material is composed of UV or visible light photoinitiator(s), UV curable resin(s), acrylate and/or methacrylate monomer(s), wetting agents, UV absorbers and stabilizers, rheology modifier(s), stabilizer(s), adhesive agent(s), self leveling agent(s) and air release agent(s). The following chart outlines the preferred materials used in accordance with the present invention. This list merely presents a suggested. shopping list from which the various ingredients of the present coating material may be obtained, and those of ordinary skill in the art will readily appreciate that the components making up the present coating material may be purchased from a variety of vendors without departing from the spirit of the present invention.

Photoinitiator(s)

The photoinatiators used in accordance with a preferred embodiment of the present invention are selected for being colorless so as to give a water white appearance; for being non-yellowing; for long term durability, for being extremely reactive for fast cures in seconds and imparting surface cure to the formulation to give hard, durable solvent resistant surfaces and giving depth of cure down to the substrate surface regardless of coating thickness.

With this in mind, the present blend of photoinitiators can be used in combination in both thick and thin UV curable protective coating systems that allow the coatings to be rapidly cured in hard, durable, repairable, thermoplastic clear coatings that are permanent, non-yellowing, abrasion resistant, stain resistant, solvent resistant, defect free and temperature resistant with exceptionally good adhesion to stone, ceramic, metals, glass, cement and hard plastics.

In accordance with a preferred embodiment of the present invention, the following photoinitiators are combined to provide a blended photoinitiator offering optimum characteristics:

| | |
|---|---|
| Kip 150 | oligomeric hydroxy ketone polyfunctional |
| (Lamberti Sp. A.) | photoinitaitor with high reactivity and non-yellowing |
| | characteristics (may be replaced with IRGACURE |
| | 184, a 1-Hydroxy-cyclohexyl-phenyl-ketone |
| | manufactured by Ciba, Inc.) |
| TZT | Liquid Benzophenone derivative |
| (Lamberti Sp. A.) | |

Wetting Agents

In accordance with a preferred embodiment of the present invention, it has been found that a blend of the following wetting agents may be utilized:

| | |
|---|---|
| FC430 | Fluorosurfactant used to provide superior substrate wetting |
| (3M Corp.) | and providing improved adhesion. |
| Byk 355 | Can be used along with many other acrylated silicones, |
| (Byk | fluoronated monomers, straight acrylics which are all well |
| Chemie) | known chemistries and are used by all formulators. |

UV Absorbers

In accordance with a preferred embodiment of the present invention, it has been found that a blend of the following UV absorbers provides desirable results:

| | |
|---|---|
| Tinuvin 1130 | Hydroxyphenyl benzotriazole is an ultraviolet light |
| (Ciba, Inc.) | stabilizer |
| Tinuvin 292 | Hindered Amine Light Stabilizer |
| (Ciba, Inc.) | |

When used in combination, in specific ratios, 2 parts Tinuvin 1130 and 1 part Tinuvin 292 these two products provide superior performance in preventing any color change in the coating when exposed to light, either sunlight or other forms.

TPO (BASF) 2,4,6 Trimethyl benzoyl diphenyl phosphine oxide

(maybe replaced with IRGACLJRE 819, manufactured by Ciba, Inc.)

This proprietary blend provides a photoinitiator with broad intense absorption over a wide spectrum of wave energy, while being non-yellowing and having rapid reactivity to low levels of intensity as found in portable UV lamps.

It is further contemplated that MBF (Methylbenzoyl formate), an aromatic ketone, may be used with the proprietary blend as disclosed above to enhance reactivity and provide for durable hard surface cures with monomers and resins which exhibit oxygen inhibition.

Trials with different ratios of the blend and MBF shows that a 1:1 ratio performs best at levels of 1-3% for both MBF and the blend. That is, and in accordance with a preferred embodiment of the present invention, the blend of oligomeric polyfunctional hydroxy ketone, liquid benzophenone and polyfunctional phosphine oxide is approximately 50% of the light photoinitiator blend and the aromatic ketone comprises the remainder of the light photoinitiator blend, while the blend of oligomeric polyfunctional hydroxy ketone, liquid benzophenone and polyfunctional phosphine oxide is between approximately 1 to 3% of the total coating weight and the aromatic ketone is between approximately 1 to 3% of the total coating material weight.

It is also contemplated that IRGACURE 184, 1-Hydroxycyclohexyl phenyl ketone, may be used in combination with MBF and TPO to provide similar performance.

Resins

In accordance with a preferred embodiment of the present invention, a novel blend of UV curable resins are employed in the coating material. The resin blend comprises approximately 10% to 60% by weight of the coating material, wherein each resin making up the blend preferably constitutes approximately 30% to 50% of the resulting curable resin blend.

This novel combination of UV curable resins can be used in both thick and thin UV curable protective coating systems. The blend provides for a coating material that rapidly cures to a hard, durable, repairable thermoplastic clear coating which is permanent, non-yellowing, abrasion/solvent/stain/temperature resistant with exceptionally good clarity. The resulting coating will further be defect-free from air bubbles, surface wrinkling and surface tackiness. Moreover, the blend provides for good adhesion to stone, ceramic, glass, metals, concrete, and hard plastics such as solid surface plastics, epoxies and acrylics.

The resins combined to form the present blend are selected from the group consisting of aliphatic linear polyether urethane acrylate having high functionality allowing for high tensile and elongation properties; multifunctional melamine triazine oligomer with high functionality; amine modified polyether acrylate with high reactivity; multifunctional tough and flexible isocyanurate resin; aliphatic polyester urethane acrylate; and polyester acrylated monomer blend with high durometer and slow cure characteristics. More specifically the aliphatic linear polyether urethane acrylate having high functionality provides for a combination of high tensile and high elongation and imparts good hydrolytic stability, good chemical resistance, good weatherability, good abrasion resistance, good gloss, non-yellowing, low viscosity and good optical clarity, multifunctional melamine triazine oligomer with high functionality provides for water white appearance, low viscosity, rapid cure speed, high temperature resistance, good hydrolytic stability, good chemical resistance, good weatherability, good abrasion resistance, good gloss, non-yellowing, good optical clarity and flexiblity modifier, amine modified polyether acrylate with high reactivity provides for excellent solvent and wear resistance, good non-yellowing and good adhesion; isocyanurate resin provides for excellent solvent and wear resistance, good non-yellowing, good adhesion, good flexibility and good hardness; aliphatic polyester urethane acrylate provides for good solvent resistance, flexible and good optical clarity, and polyester acrylate monomer blend provides for very high hardness, excellent solvent resistance, low viscosity, cure modifier and non-yellowing.

In accordance with a preferred embodiment of the present invention, an aliphatic linear polyether urethane acrylate as embodied in U.S. Pat. No. 5,578,693, entitled “Multifunctional terminally unsaturated urethane oligomers”, which is assigned to Bomar Specialities Co. and incorporated herein by reference, is utilized. In addition, and also in accordance with a preferred embodiment of the present invention, a multifunctional melamine triazine oligomer (specifically BMA-250) manufactured by Bomar Specialities Co. is utilized.

The following resin blends have been contemplated for use in accordance the present invention and found to provide ideal properties for the coating disclosed in accordance with the present invention:

A blend of aliphatic linear polyether urethane acrylate having high functionality allowing for high tensile and elongation properties and amine modified polyether acrylate with high reactivity provide stain resistance, high adhesion, fast curing for sealing surface and graffiti resistance.

A blend of amine modified polyether acrylate with high reactivity and multifunctional tough and flexible isocyanurate resin provide a permanent hard stain resistant surface with low viscosity as used in a clear, water white thin coat for stone such as marble, onyx and metals.

A blend of aliphatic linear polyether urethane acrylate having high functionality allowing for high tensile and elongation properties and multifunctional melamine triazine oligomer with high functionality provide a glass coating offering very hard, clear, distortion free surfaces with rapid cure, self leveling and also temperature and flame resistance.

A blend of multifunctional melamine triazine oligomer with high functionality and polyester acrylated monomer blend with high durometer and slow cure characteristics provide a glass coating offering very hard clear distortion free surfaces and flame resistance.

Monomers

The following monomers are examples of combinations of monomers used in accordance with the present invention. In accordance with a preferred embodiment of the present invention the monomer utilized comprises a blend of families of different acrylate and methacrylate monomers. More preferably, the acrylate monomers are monofunctional and multifunctional acrylates and the methacrylate monomers are monofunctional and multifunctional methacrylates. In practice, the monomer blend will constitute approximately 40% to 90% by weight of the coating material. The monomer combinations used in accordance with a preferred embodiment of the present invention, and discussed below in greater detail, impart the unique properties necessary for the present coating to function in the manner discussed above.

The monomers are outlined below with their specific characteristics and then disclosed in combinations for specific properties.

| | |
|---|---|
| HDODA | fast curing, low volatility, good weatherability, good chemical resistance, |
| | good adhesion, good hardness, good heat resistance, good abrasion |
| | resistance |
| IBOA | High Tg properties, excellent reactivity, good flexibility, good impact |
| | resistance, good water resistance for thin film curing |
| IBOMA | Similar properties to IBOA but with a slower cure for thick curing sections |
| | to prevent surface distortion (wrinkling) |
| TMPTA | Fast cure response, low volatility, good weatherability, good chemical |
| | resistance, good hardness, good heat resistance, good abrasion resistance |
| TMPTMA Ethoxlated | Similar properties to TMPTA but with a slower cure for thick section cure. |
| | Low shrinkage, very low viscosity good weatherability, good chemical |
| TMPTA | resistance, good adhesion, good hardness, good heat resistance, good |
| | abrasion resistance, good impact. Used for thick section curing because of |
| | low shrinkage and slower curing. |
| HEMA | Cross linkable, hydrophobic, improved adhesion, critical for glass bonding |
| HPMA | Used in combination with HEMA for glass bonding in ratio of 2 to 4 parts |
| | HEMA with 1 part HPMA |

Similar monomers in the families could provide similar properties but at possible higher cost.

The following monomer combinations are contemplated for use in accordance with the present invention:

HEMA, HPMA, HDODA—used for glass bonding

IBOA, TMPTA—used for marble coating, stone sealing and graffiti coating and metal coating where thin coatings of 0.1-3.0 mil are required.

TMPTMA, IBOMA, Ethoxylated TMPTA—used for marble coating, stone coating, metal coating where thick coats of approximately 3.0-30 mils are desired.

Adhesion Promotion Agents

The following adhesion promotion agents are used both in the coatings and separate preapplied primers:

Acrylic acid

Epoxy Silane

Trifunctional acid ester

When used in conjunction with a primer, the above materials are used at a level up to 5% in a solvent based system such as alcohol or acetone.

In fact, testing on glass, marble and metal surfaces show that the preapplied primer provides improved adhesion; for example, 25-70% improvement depending on the application and long term durability.

The following additional products may be used by coating formulators to impart specific properties to the final formulation and are not considered unique but are included in an effort to provide an explanation for the best mode of practicing the present invention:

| | | |
|---|---|---|
| Leveling agent such as: | 3500, 3503, 3505 | Witco |
| | Modflow 2000 | Monsanto |
| Air Release agent such as: | Byk 550 | Byk Chemie |
| Stabilizers such as | chelating agents | Monsanto |
| | Dequest 2010 | Hampshire |
| | Hampene NA4 | |
| Adhesive agents such as: | acrylic acid, | Elf Atochem |
| | Methacrylic acid | generic |
| | CD9051 ester | Sartomer |
| Rheology modifiers such as | r200 | Degussa |
| | HdkN20 | Wacker |
| | M-5 | Cabot |

In addition, the following components may be added to impart desired characteristics: fillers, textured fillers for imparting surface texture to match substrate textures, fungicides for preventing mildew and bacteria growth in sealants, pigments as needed for color matching to specific requirements and flame retardants to reduce flame spread and smoke.

In accordance with a preferred embodiment of the present invention, it has been found that ideal results are produced where the components of the present coating material are combined in the following manner: resins approximately 10% to 60% by weight, acrylate and/or methacrylate monomers approximately 40% to 90% by weight, photoinitiators approximately 2% to 6% by weight, UV absorbers approximately 0.5% to 2.0% by weight, leveling agents approximately 0.3% to 1% by weight, stabilizers approximately 0.1% to 0.5% by weight, adhesive agents approximately 5% to 10% by weight, rheology modifiers approximately 0.5% to 5.0% by weight, and wetting agents approximately 0.2% to 0.5% by weight.

As discussed above, various miscellaneous additives may be included in the coating material. For example, the following additives maybe included in the preferred quantities as noted: texture fillers to impart surface texture to match substrate texture at approxinately 5% to 20% by weight of the coating; fungicides to prevent mildew and bacteria growth at approximately 1% to 10% by weight of the coating; pigments as needed to color match to specific surfaces at approximately 0.2% to 5.0% by weight of the coating; flame retardants to enhance the reduction of flame spread, smoke production and toxic fumes at approximately 5.0% to 20% by weight of the coating; particulate materials (examples maybe: aluminum oxide powder, silicon carbide powder, silicates and ground plastics) at approximately 1% to 5% by weight of the coating, post applied to the wet coating for providing a permanent, clear coating with high frictional properties in dry, wet or oily conditions to provide a rough, non slippery surface; and acrylated and methacrylated silicons to enhance the anti-graffiti properties at approximately 1% to 10% by weight of the coating.

The various components of the present coating material offer added functionality resulting in the highly useful coating system of the present invention. For example, the blending of several photoinitiators provides the coating system with full depth cure in thick sections. The blending of several photoinitiators also provides a hard surface while preventing surface distortion.

In addition, the total coating system is formulated to prevent oxygen from inhibiting the ultimate curing of the coating material. The UV absorbers and stabilizers are blended to maximize the coating system's sunlight durability for clarity of appearance. The blended resins provide a permanent, water-white clarity when cured, offering mar resistance, impact resistance and wear resistance. The selected monomers minimize the odor of the coating of the material, while also maximizing toughness. The wetting agents provide humidity resistance, surface wetting and leveling properties to the coating system in conjunction with the leveling agents used. The air release agents allow entrapped air contained within the liquid coating during application to come to the surface and be release to avoid “pit marks”. Finally, the adhesive agents provide adhesion for the bonding of the present coating system to various substrates including, but not limited to, metals, glasses, designer plastics, stone and marble.

The various components of the present coating material in accordance with the present invention include no VOC or HAPS related solvents, are environmentally friendly, and are not regulated in any form for use or transportation. In addition, the various components do not require special protective equipment other than normally used with chemicals. In addition, the coating material may be readily formulated to provide a large range of viscosities to be used for thin coats and thicker coatings for interior and exterior applications on a multitude of surfaces. The coating material may also be pigmented or dyed to effect matching colors while not inhibiting the photopolymerization of the coatings. Being a thermoset plastic, the cured coating material offers good solvent, moisture and temperature resistance, provides a hard, durable surface and may be repaired and/or reapplied over the initial coating without loss of aesthetic appeal or physical properties.

In use, the coating material, depending upon its viscosity, is simply brushed, rolled or sprayed onto surfaces in thicknesses from 1 mil to 40 mils. Where appropriate, the coating material may be applied in conjunction with a diluted silane or ester primer to improve the adhesion and durability of the coating bond to the exposed surface of the desired substrate. The coating system may be cured using commercially available industrial radiation type lamps with appropriate bulbs to produce the desired wavelength spectrums which facilitate curing within seconds of exposure.

The durability, hardness and reparability of the present coating system make it an ideal protective coating for a wide variety of applications. Various contemplated uses are discussed below. However, the listed uses are merely exemplary of the possible uses for the present coating material and method. As such, those skilled in the art may appreciate other uses which are certainly considered to be within the scope of the present invention.

Frictional Surfacing Material

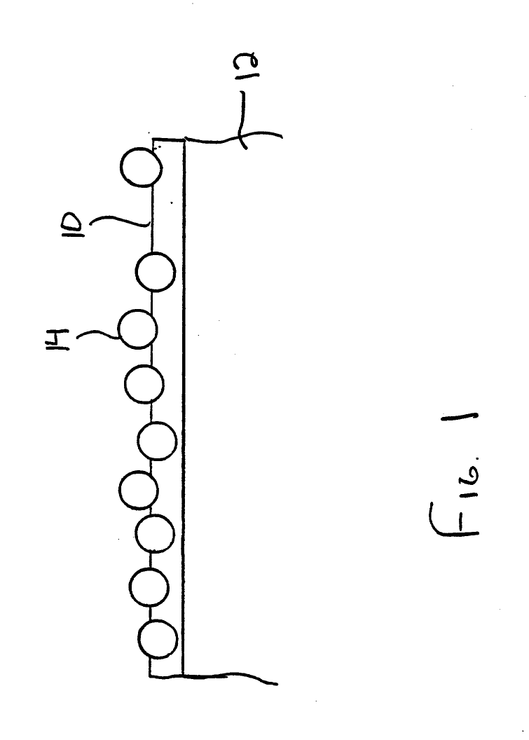

The coating material described above in accordance with the present invention offers frictional characteristics providing an anti-skid (non-slip) surface 10, while allowing the substrate material 12 to be visible through the transparent coating 10 (see FIG. 1). Where prior art coatings covered and hid the color and design of the substrate flooring material, or became easily discolored, marred or worn away, the present photopolymerizable coating is readily transparent, non-yellowing and has good wear resistance when combined with grit, or a hard particulate 14.

The frictional properties of the present photopolymerizable coating system, when used in conjunction with a hard particulate placed on the surface of the coating, make it an ideal coating for slippery surfaces where water or other liquids are commonly present. For example, it is contemplated that the present coating system may be applied to the smooth surfaces commonly found in pool/spa/shower areas, commercial kitchens, food processing areas, terrazzo/marble/granite floors in commercial lobbies, public transportation areas, bath tubs and bathroom floors.

The frictional properties of the coating system as enhanced by the addition of anti-slip particulate, such as, aluminum oxide powder on the coating material, converts previously smooth, glass-like and dangerous surfaces to highly slip-resistant surfaces without hiding the exposed surface of the coated substrate. Once applied, the coating system is easily cleaned. In addition, the coating system in accordance with the present invention may be readily repaired if damaged while maintaining its appearance both on the exterior and interior applications. This is achieved by the simple addition of new coating to the old.

An anti-skid coating in accordance with the present invention is created by first applying the coating material described above to the surface to be coated and subsequently broadcasting a particulate material onto the coating material discussed above. The particulate material may be chosen from the group consisting of aluminum oxides, colored epoxy powders, silicon carbide, granulated clear HDPE, quartz and granulated shell materials. While the disclosed particulate materials are contemplated for use in accordance with a preferred embodiment of the present invention, other particulate materials may be used on other durable flooring surfaces without departing from the spirit of the present invention.

As mentioned above, the particulate material is spread, that is, applied on the surface of the previously applied coating material. It is contemplated that the particulate should be applied at a rate of 1 ounce to 2 onces per sq. ft. depending on the specific gravity of the particulate and the desired aesthetic qualities. While a specific quantity of particulate is disclosed for use in accordance with the present invention, those skilled in the art will appreciate that this quantity may also be varied without departing from the spirit of the present invention.

Once the particulate is incorporated onto the coating material, the coating material is cured with the radiation curing lamps. Where the coating is applied in a small area, hand held curing lamps may be used, while caster mounted large curing lamps are used where the coating is applied to a large surface.

In accordance with a preferred embodiment of the present invention, the anti-skid coating is applied in the following manner:

1) Preparing the floor area by nomally washing, rinsing and drying to remove dirt, grease, wax or other surface contamination. In cases where damage is severe, sanding, buffing or other removal processes maybe necessary.

2) Applying a dilute solution of primer in solvent to the surface to create greater adhesion to certain substrates or improved long-term moisture resistance by wiping, rolling or brushing in a thin coat.

3) Allowing the solvent to “flash off”.

4) Applying the present photopolymerizable coating material to the primed surface with a squeegee, notched tool, roller, brush. Similarly, the present photopolymerizable coating material may be applied by spraying or flooding and allow the coating material to self-level and release air, normally 10-15 minutes depending on temperature and thickness. This is intended to be a permanent coating as opposed to strippable UV coatings as used on vinyl, wood and other surfaces.

5) Applying particulate to the coated area by broadcasting, or other dispersion method, in the desired density.

6) Curing the coating with the radiation lamps for a sufficient period to effect total polymerization of the coating so that the surface is hard and dry to the touch.

7) If any particulate is loose on the surface, vacuum or sweep away.

Application of the present coating system in this manner provides the treated surface with a high friction surface, minimizing the likelihood that one might slip and fall while in contact with the treated surface. In addition, the coating is transparent and does not alter the aesthetic appearance of the underlying surface. In addition to the speed of cure, the coating process lends itself to applications where access to an area must be maintained and sections may be coated in a systematic manner to allow use while coating proceeds, for example, in health care, public transportation, and commercial areas. The coating further provides protection for the underlying surface in a manner discussed below in greater detail.

Glass Coating System

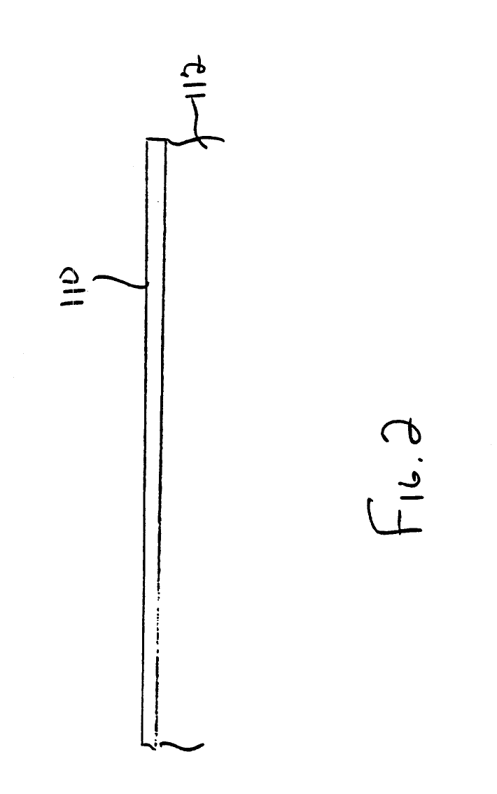

The coating system is also well suited for use as an impact resistant coating 10 on laminated or tempered glass 12 (see FIG. 2). When used in such applications, the coating system helps to prevent spalling of the laminated or tempered glass where the glass is impacted on the uncoated side and shattering of the impact area occurs, such as with a stone or other projectile hitting the glass. In addition, the application of the present coating system to a glass surface reduces the repair/replacement factor, and ultimate cost for damaged glass, due to vandalism caused by the scratching of designs and graffiti into the glass surface. Specifically, the coating system protects the glass surface by preventing the scratching of the glass itself which would necessarily be replaced if scratched or otherwise defaced. The present coating system acts as a sacrificial coating which is scratched instead of the underlying glass surface. As compared with the glass surface itself, the hard, plastic coating is easily repaired by resurfacing, recoating over the scratch, or utilizing a combination of resurfacing and recoating to treat the affected marred area.

The coating material is applied to the laminated or tempered glass surface which is designated as the surface to be protected in the following manner:

1. The marred glass surface is prepared by sanding, sandblasting, honing or other surface preparation method to remove the objectionable defacement. This also allows for greater adhesion of the coating to a clean, prepared surface in that sanding, blasting or honing increases the effective microscopic surface area several fold by increasing the surface roughness factor.

2. The prepared surface is then primed with a solvent-based dilution of a silane and/or methacrylate ester adhesion promotion agent by applying a thin uniform coating to the entire surface. The primer can be wiped, squeezed or applied with other thin coating application methods. The solvent is allowed to evaporate, leaving a very light coating of the active chemical which creates reactive sites for the chemical coating on the glass surface. In the case of silane, there is a well documented relationship of improved moisture and humidity resistance of silane prepared glass when used with coatings and adhesions over long periods of time.

3. The glass surface is then leveled to create a horizontal surface to prevent uneven thickness of the coating due to gravity. The photopolymerizable reactive chemical coating material is then applied by brush, roller or spray method.

4. The applied coating material is then allowed to self level and air release on the flat glass surface for 5-20 minutes. The coating thickness is normally 0.004 inches for a thin coat to 0.030 inches for a heavy coat of a the scratch resistant coating. The coating can also be spread with the use of a draw rod or doctor's blade using shims on the side of coating surface to act as thickness gauges. Such a system would require guides on each side of the coating area and pouring a known weight of coating material onto the surface (x oz per sq ft) and then using a glass draw rod to pull the material across the glass until the entire area is covered with the proper thickness with a small amount of runoff. If air bubbles or irregularities in the coated surface appear, the use of heat from a hot air gun, radiation heating panel or actual torch flame will eliminate these problems by gently waving the heat source above the surface for a few seconds.

5. When the coated glass surface appearance and thickness are satisfactory, the surface is cured by exposure to radiation curing lamps equipped with the proper bulb type to generate the wave energy spectrum needed to effect full cure of the body of the coating as well as the surface. Experimentation has shown that two radiation bulbs give optimum results, initial exposure is by a D bulb which generates long wave energy in the 365 nanometers wavelength area for depth of cure followed immediately by exposure to an H bulb generating the majority of its wave energy in the 300-310 nanometers wave length spectrum Curing takes 1-5 seconds under each lamp or a total of 10 seconds for most applications to achieve full cure. The radiation cured coating is dry to the touch immediately and upon cooling to room temperature is ready for installation or packaging.

With regard to vandals scratching or defacing glass on subway cars, buses, trains, terminals or building/store windows, etc., glass surfaces coated as discussed above may be readily repaired by simply sanding off the initial coating and replacing the same with a new coating applied in the manner discussed above. Specifically, the hardness of the present coating system permits vandals to scratch graffiti into the coating but substantially prevents the vandals from scratching through the coating and into the glass itself. As a result, it is not necessary to replace an entire window once a vandal scratches graffiti thereon; it is only necessary to remove the initial coating affected by the vandalism and reapply the coating thereon.

The present coating system works well with vandals because it is easier to scratch than glass and vandals are generally interested only in leaving their “tag” on the surface, not destroying the surface. This allows an easily repaired surface to be refinished faster and cheaper since the intended damage is less than on the hard glass.

Specifically, repair of scratched glass is achieved by buffing out the scratch, locally if possible, recoating the area and radiation curing the coating. Many times, light scratching or very localized scratching can be done with the glass in place in a vertical position. For deep scratches or full glass sanding, removal and horizontal working is easier and faster before recoating the entire surface.

For cosmetic covering of light scratches, recoating the area with a lower viscosity coating is possible. This does not require any sanding or refinishing.

Protective Coating Material

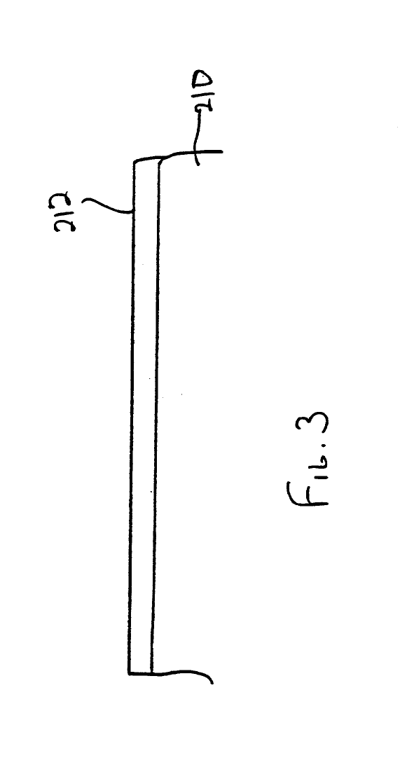

The present coating system 212 maybe further used to impart scratch and solvent resistance to various substrates 210 (see FIG. 3), such as, vanity tops of solid surfacing materials (for example, CORIAN by DuPont), marble, granite, ceramic tile and glass furniture. The coating system may also be used within shower and tub enclosures to prevent the buildup of mildew and soap residue on the wall surfaces and grout.

The coating system may further be applied to brass, bronze, anodized aluminum, and other decorative metal surface substrates to prevent scratching and damage in their day-to-day use. For example, anodized aluminum luggage racks, brass hand rails, elevator doors and panels, and bronze plaques may be treated in accordance with the present invention to minimize the need for regular shining, polishing, cleaning and replacing. While specific materials are proposed above for treatment in accordance with the present invention, those skilled in the art will appreciate the many other materials and objects which maybe treated within the spirit of the present invention.

As briefly discussed in the Background of the Invention, prior art coating systems generally use highly solvated acrylic lacquers as sold in automotive shops in spray cans for spray application on these surfaces to prevent oxidation as well as corrosive attack from acid rain, human touch or other corrosive media. The present acrylic technology is harmful to the atmosphere, is highly flammable and toxic, can not be used in enclosed spaces and leaves only a minimal coating on the surface which provides pinholes for oxidation to occur. The present photopolymerizable reactive coating maybe applied in many different ways, but creates an impervious barrier to moisture, humidity, human oils and residue. The present coating material has no solvents, is nonflammable, is VOC compliance, and is easily cured in seconds to a hard, durable surface which is non yellowing and scratch resistant.

Despite the hardness and nonporous character of the present coating system, the present coating system may be damaged by scratching, normal wear and aggressive chemicals. However, the present coating system substantially protects the underlying surface from scratches and oxidation, keeping it bright and shiny for prolonged periods of time. As a result, it is not necessary to replace an entire piece once it is damaged by scratching or caustic materials; for example, it is only necessary to buff light scratches in the initially affected coating to restore the brilliance and to reapply the coating without removing the initial coating for heavy marine applications.

Coating and curing of large area substrates is normally done by spray equipment or rollers in thin coatings of 0.001 to 0.005 inches. For small areas the present coating material can be applied with brushes or wiping on. Once applied, the coating material self levels and air releases in seconds. The coating material is then cured with hand held lamps using an H bulb or D bulb. Since the coating is so thin, the wavelength spectrum used to effect cure is not as important as thicker coatings to 0.025 inches where wrinkling or distortion may occur.

Surfaces prepared in this manner are provided with a nonporous, durable and transparent coating which is not readily affected by damaging chemicals and scratching. Where the treated surface is damaged by scratching or caustic materials, the underlying surface is protected and one need only reapply the coating to return the object to its original appearance. After several years of heavy use, the damaged surface is easily repaired by simply stripping off the initial coating with marine grade varnish remover, reapplying a new coating and curing in the manner discussed above.

Anti-Graffiti System

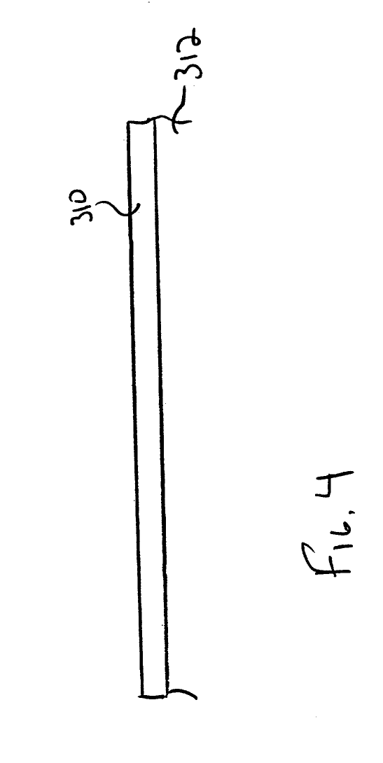

Finally, the coating system 310 may be applied to painted, plastic and porous surfaces 312 as an anti-graffiti coating based upon the highly repairable nature of the coating system (see FIG. 4). Use in this manner enables the removal of scratch marks, blemishes, stains, or graffiti by simply buffing, polishing and/or solvent wiping the treated surface. With this in mind, the present coating material may be applied to a variety of porous or solvable surfaces subjected to graffiti etc., for example, marble, granite, concrete, stone, thermoplastics and anodized aluminum.

These surfaces commonly absorb stains, ink, paint and colorants of all types into their surface structure, making removal therefrom extremely difficult if not impossible. As briefly discussed above in the Background of the Invention, prior art coating techniques involve applying water based (emulsions) or solvent-based dilutions of urethane, silicones, pt. emulsions or other slippery, surface sealing materials to prevent absorption and adhesion. They have a limited life, they can be disturbed by water or solvents and they must be applied in repeated coats to get any significant buildup for long lasting protection. Prior art coatings deposit only 15-40% of the volume of the coating after evaporation and are non-reactive so adhesion on smoother surfaces such as marble is very limited.

The present invention overcomes these shortfalls by providing an impervious chemical barrier. The present coating system prevents entry of the graffiti colorants into the porous underlying surfaces which are very difficult and expensive to clean.

Once applied to a specific substrate, the present coating system may be repaired in a variety of ways after being affected by graffiti, such as, paints, spray cans, inks, nail polish etc. For example, where a marring agent has stained the surface of the coating system, the coating system may be cleaned with solvents such as IPA and surfactants. If solvents do not totally remove the stain, the coating maybe sanded away to remove the stain. The sanded portion of the coating is then replaced by the simple application and curing of the coating material. In fact, the viscosity of the coating material allows an individual to roll or spray the coating material on the sanded area, wait while the coating material self-levels and is absorbed into the outer porosity and cure the coating material with small hand held UV lamps.

Where the coating is scratched, repair is achieved by sanding away the scratch coating and reapplying the coating in the same manner as discussed above with regard to the removal of a stain. Alternately, where the scratch permits, an individual may simply apply the coating material within the scratch, cure the coating material and lightly sand the newly applied coating until it conforms with the existing surface.

In summary, the many features of the present coating system offer a multitude of benefits to those in need of a protective coating. For example, the extremely fast curing rate of the present coating system provides limited downtime at commercial and residential properties, the low odor level of the coating material generates no residual odors that might be offensive to nearby individuals, and the hard, tough surface produced by the coating system is mar resistant. In addition, the high film integrity offered by the coating system provides impact resistance, while the low viscosity of the coating material results in thin coating thicknesses. Additional benefits include a non-yellowing coating system providing outdoor color durability, a clear, transparent coating invisible on surfaces and a glass-like refractive index making the coating system suitable for applications on glass. Finally, the coating system is solvent resistant allowing for use on countertops, vanities, bathroom sink areas normally susceptible to various staining and marring materials used in cosmetics, body lotions, aftershave lotions, drinks and beverages (rings).

The present coating system provides a clear, hard, dry to the touch coating which may be applied in thick or thin coatings to durable surfaces for providing protection from solvents, scratching or discoloration. The coating system may be applied to a variety of surfaces, either horizontally or vertically oriented, and is easily applied, repaired and cleaned to maintain the desired appearance of the coated substrate. The coating system protects new surfaces, restores damaged surfaces or adds safety to potentially dangerous slippery surfaces. These applications are found in commercial buildings, such as, hotels, banks, restaurants, banks, transportation terminals, convention centers, residential buildings, such as, homes, health care facilities of nursing homes, hospitals, clinics, spas, health clubs, exercise clubs and industrial buildings, such as, plant showrooms and lobbies.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A radiation curable reactive coating material, comprising:
a light photoinitiator, the light photoiniator comprising a blend of oligomeric polyfunctional hydroxy ketone, liquid benzophenone, polyfunctional phosphine oxide, and an aromatic ketone;
a blend of UV curable resins, the blend being chosen from the group consisting of aliphatic linear polyether urethane acrylate having high functionality allowing for high tensile and elongation properties, multifunctional melamine triazine oligomer with high functionality, amine modified polyether acrylate with high reactivity, multifunctional tough and flexible isocyanurate resin, aliphatic polyester urethane acrylate, and polyester acylated monomer blend with high durometer and slow cure characteristics;
a monomer,
a wetting agent which comprises approximately 0.2% to 0.5% by weight of the total coating weight;
a UV absorber and stabilizer which comprises approximately 0.5% to 2.0% by weight of the total coating weight;
a rheology modifier which comprises approximately 0.5% to 5.0% by weight of the total coating weight;
a stabilizer which comprises approximately 0.1% to 0.5% by weight of the total coating weight;
an adhesive agent which comprises approximately 5% to 10% by weight of the total coating weight; and
a self leveling agent which comprises approximately 0.3% to 1.0% by weight of the total coating weight.

2. The coating material according to claim 1, wherein the oligomeric polyfunctional hydroxy ketone is Kip 150 or IRGACURE 184, the liquid benzophenone is TZT, the polyfunctional phosphine oxide is TPO or IRGACURE 819 and the aromatic ketone is MBF.

3. The coating material according to claim 1, wherein the blend of oligomeric polyfunctional hydroxyketone, liquid benzophenone and polyfunctional phosphine oxide is approximately 50% of the light photoinitiator blend and the aromatic ketone comprises the remainder of the light photoinitiator blend.

4. The coating material according to claim 1, wherein the blend of oligomeric polyfunctional hydroxy ketone, liquid benzophenone and polyfunctional phosphine oxide is between approximately 1 to 3% of the total coating weight and the aromatic ketone is between approximately 1 to 3% of the total coating material weight.

5. The coating material according claim 1, wherein the blend of UV curable resins includes aliphatic linear polyether urethane acrylate having high functionality allowing for high tensile and elongation properties and amine modified polyether acryiate with high reactivity to provide for stain resistance, high adhesion and fast curing for sealing surfaces such as required in graffiti resistant coatings and thin transparent coatings to marble/onyx/stone bar tops, restaurant table tops counters, bathroom vanities and other commercial surfaces where food, drink, cosmetics or other organic chemical substances are present.

6. The coating material according to claim 5, wherein the blend of UV curable resins comprises approximately 10% to 60% by weight of the total coating weight.

7. The coating material according claim 1, wherein the blend of UV curable resins includes aliphatic linear polyether urethane acrylate having high functionality allowing for high tensile and elongation properties and multifunctional melamine triazine oligomer with high functionality for glass coating to provide for very hard, clear, self leveling, distortion-free liquid coating which when cured provides temperature and flame resistance.

8. The coating material according to claim 7, wherein the blend of UV curable resins comprises approximately 10% to 60% by weight of the total coating weight.

9. The coating material according claim 1, wherein the blend of UV curable resins includes amine modified polyether acrylate with high reactivity and multifunctional tough and flexible isocyanurate resin to provide a low viscosity, water-white, permanent, hard, stain-resistant surface to give very thin, natural looking stone coating surfaces for various stones.

10. The coating material according to claim 9, wherein the blend of UV curable resins comprises approximately 10% to 60% by weight of the total coating weight.

11. The coating material according claim 1, wherein the blend of UV curable resins includes multifunctional melamine triazine oligomer with high functionality and polyester acrylated monomer blend with high durorneter and slow cure characteristics for glass coating to provide a very hard scratch resistant coating having exceptional clear, transparent, distortion-free cured surfaces and flame resistance.

12. The coating material according to claim 11, wherein the blend of UV curable resins comprises approximately 10% to 60% by weight of the total coating weight.

13. The coating material according to claim 1, wherein the blend of UV curable resins comprises approximately 10% to 60% by weight of the total coating weight.

14. The coating material according to claim 13, wherein each resin making up the blend of UV curable resins constitutes approximately 30% to 50% of the blend of UV curable resins.

15. The coating material according to claim 1, wherein the monomer is composed of a blend of monomers.

16. The coating material according to claim 15, wherein the blend of monomers is a blend of families of different acrylate monomers and methacrylate monomers.

17. The coating material according to claim 16, wherein the acrylate monomers are monofunctional and multifunctional acrylates and the methacrylate monomers are monofunctional and multifunctional methacrylates.

18. The coating material according to claim 17, wherein the acrylate monomers and methacrylate monomers are chosen from the group consisting of HEMA, HPMA, HDODA, IBOA, TMPTA, TMPTMA, IBOMA and Ethoxylated TMPTMA

19. The coating material according to claim 18, wherein the blend of acrylate monomers and methacrylate monomers consists essential of HEMA, HPMA and HDODA which is used for glass coating or glass bonding.

20. The coating material according to claim 18, wherein the blend of acrylate monomers and methacrylate monomers consists essential of IBOA and TMPTA which is used for marble coating, stone sealing, graffiti coating or metal coating where thin coatings of 0.1 -3.0 mils are required.

21. The coating material according to claim 18, wherein the blend of acrylate monomers and methacrylate monomers consists essential of TMPTMA, IBOMA and Ethoxylated TMPTMA which is used for marble coating, stone coating or metal coating where thick coats of approximately 3.0-30 mils are desired.

22. The coating material according to claim 15, wherein the blend of acrylate monomers and methacrylate monomers comprises approximately 40% to 90% by weight of the total coating weight.

23. The coating material according to claim 1, further including air release agent comprising approximately 0.5% to 1.0% by weight of the total coating weight.
